(19) United States
(12) Patent Application Publication
(10) Pub. No.: US 2009/0321431 A1
(43) Pub. Date: Dec. 31, 2009

(54) Anti-splatter cover for microwave cooking

(76) Inventors: Rasha Wafikzaki Farag, Cumming, GA (US); Jeffrey E. Fish, Winston-Salem, NC (US); Michael S. Brunner, Roswell, GA (US); Tamara L. Mace, Marietta, GA (US)

Correspondence Address: KIMBERLY-CLARK WORLDWIDE, INC.;Tara Pohlkotte, 401 NORTH LAKE STREET, NEENAH, WI, 54956, US

(21) Appl. No.: 12/215,486

(22) Filed: Jun. 26, 2008

(51) Int. Cl. H05B 6/80; B23P 17/00

(52) U.S. Cl. 219/734; 29/592

(57) ABSTRACT

A disposable cover for use in a microwave for covering food with or without food vessels. The cover is flexible and may be folded flat for storage. When unfolded, the cover forms a three-dimensional structure that is self-supporting. The cover may include an optional window.

### BACKGROUND OF THE INVENTION

The present invention generally relates to field a dish and food covers, and more particularly relates to a disposable article for covering dishes and food during microwave cooking.

When food is heated in a microwave, water molecules within the food become excited resulting in a buildup of pressure. This pressure escapes from food in the form of steam. Frequently, the release of steam is sudden, like an eruption, which causes food to splatter. Therefore, whenever food is heated in a microwave, it should be covered to prevent splattering food particles from soiling the interior of the microwave.

Existing disposable food covers do not provide consumers with convenient, easy-to-use covers for microwave cooking. For example, wax paper absorbs much of the moisture produced by cooking and becomes quite soggy and difficult to handle after heating the food. Like wax paper, paper towels tend to droop into the food and absorb too much moisture from the food. Further, paper towels may stick to the food. Both wax paper and paper towels can easily fall off the food, especially when there is a turn-table in the microwave. Plastic films may be used to cover food for microwave heating, however, because of the potential concern that chemical contamination can occur, it is recommended by some consumer and environmental groups that such films do not touch the food. This can be a difficult recommendation to follow, because when heated food starts to cool a vacuum may be formed which pulls the plastic film into contact with the food. In addition, any steam that builds up under the plastic can be quite dangerous. Steam burns may occur if a person lifts up a plastic film that has not been properly vented during cooking.

Existing disposable food covers seem to have little effect in preventing hot spots from occurring during the heating process. For example, using plastic film to cover food for reheating can cause certain parts of the food to become overcooked or tough.

Accordingly, there exists a need for overcoming the disadvantages of the prior art as described above.

### SUMMARY OF THE INVENTION

The present invention is an article for covering a body of food for microwave heating. The article is made from a flexible sheet defining an outer surface and an opposite food-facing surface, and a top portion and a side portion, wherein the side portion comprises a plurality of panels permanently attached together to form seams. The top portion lies in an intersecting plane with respect to the side portion, and is elevated above a plane by the side portions to create a volume.

In another aspect of the invention there is a method of manufacturing a three-dimensional article for covering a body of food for microwave heating having the steps of:

forming a blank from a sheet of material by creating an overall shape;

placing a plurality of notches in the blank that extend from an outer edge toward a center point, each of the plurality of notches defined by a pair of inner edges converging into a corresponding apex; permanently attaching each pair of inner edges together to form seams, wherein each of the seams extend from the outer edge to the corresponding apex;

wherein the step of permanently attaching each pair of inner edges creates the three-dimensional article having a volume by creating a top portion and a side portion.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a front elevated cross-sectional view of a heated dish within a microwave covered by one embodiment of the anti-splatter cover of the present invention.

FIG. 2 is a plan view of a blank used to create one embodiment of the anti-splatter cover of the present invention.

FIG. 2A is a cross-sectional view of a seam between panels on any of the embodiments of the present invention.

FIG. 3 is a front elevated cross-sectional view of a heated dish covered by the anti-splatter cover of FIGS. 1 and 2.

FIG. 4 is a front perspective view of a heated dish within a microwave covered by another embodiment of the anti-splatter cover of the present invention, this embodiment having a translucent window.

FIG. 5 is a plan view of a blank used to create the embodiment of the anti-splatter cover shown in FIG. 4.

FIG. 6. is a plan view of a blank used to create an alternative embodiment of the anti-splatter cover having a translucent window.

FIG. 7 is a plan view of a blank used to create yet another alternative embodiment of the anti-splatter cover of the present invention.

### DETAILED DESCRIPTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention and virtually any appropriately detailed structure. Further, the terms and phrases used herein are not intended to be limiting; but rather, to provide an understandable description of the invention.

The terms “a” or “an”, as used herein, are defined as one or more than one. The term plurality, as used herein, is defined as two or more than two. The term “connected,” as used herein, is an attachment that is not necessarily direct and not necessarily mechanical.

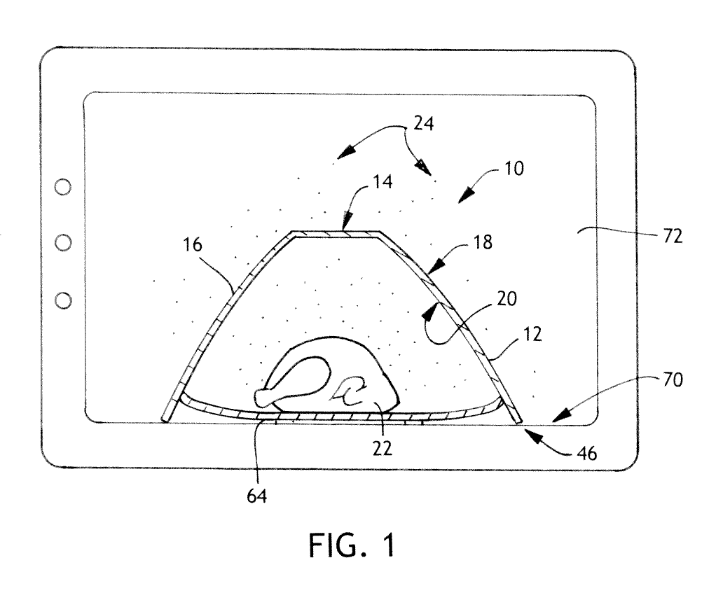

In FIG. 1 there is shown a cross-sectional view of an article 10 for preventing food from splattering during microwave cooking. Article 10 can generally be described as a tent or dome defined by a top portion 14 that is surrounded by a side portion 16. The top portion 14 lies in an intersecting plane with respect to the side portion 16, to form somewhat of a flat top. Article 10 has an outer surface 18 and an opposite food-facing surface 20. Desirably, the food-facing surface 20 does not make contact with the food 22 that is being heated. This of course depends on having the user select an appropriately-sized article 10 that will cover the body of food prior to heating.

In one embodiment of the present invention, water vapor 24 that was generated by heating food 22 may pass through sheet 12. In another embodiment of the present invention, the food-facing surface 20 may be coated with a material that may affect the transmission of water vapor 24 therethrough. Both embodiments present the advantage that the article 10, though flexible and foldable, can stand up on its own and are of one-piece construction.

Article 10 desirably conforms with the shape of a container with which it is to be used. As most dishes have a circular shape, a desired geometrical shape for article 10 is a circular dome. However, various other shapes capable of forming a triangular, rectangular, hexagonal, or other shaped tent may be desired. Regardless of the shape, it is most desirable that the article 10 does not make contact with the food before and after the act of heating occurs.

Article 10 may be made from a sheet 12 of material, which is capable of being cut into a blank, attached to itself, and folded, and which is stiff enough to hold a preferred shape so that it does not contact the food 22 before or after microwaving. Suitable materials for sheet 12 include paper (e.g. parchment, freezer paper, coffee filter paper) or non-woven materials. One suitable material for the sheet 12 is a spunbond made from rayon, polypropylene, and/or polyester (including the most common polyester for fibers—poly ethylene terephthalate or PET). As used herein, the term “spunbond” web or facing generally refers to a web containing small diameter substantially continuous fibers. The fibers are formed by extruding a molten thermoplastic material from a plurality of fine, usually circular, capillaries of a spinnerette with the diameter of the extruded fibers then being rapidly reduced as by, for example, eductive drawing and/or other well-known spunbonding mechanisms. The production of spunbond webs is described and illustrated, for example, in U.S. Pat. No. 4,340,563 to Appel, et al., U.S. Pat. No. 3,692,618 to Dorschner, et al., U.S. Pat. No. 3,802,817 to Matsuki, et al., U.S. Pat. No. 3,338,992 to Kinney, U.S. Pat. No. 3,341,394 to Kinney, U.S. Pat. No. 3,502,763 to Hartman, U.S. Pat. No. 3,502,538 to Levy, U.S. Pat. No. 3,542,615 to Dobo, et al., and U.S. Pat. No. 5,382,400 to Pike, et al., which are incorporated herein in their entirety by reference thereto for all purposes. Spunbond fibers often have a diameter of from about 10 to about 20 micrometers.

In another embodiment of the present invention, sheet 12 is a tea-bag paper made with a blend of wood and vegetable fibers. The vegetable fiber may be bleached or unbleached cellulosic pulp from wood (e.g. abaca hemp, a small plantation tree grown for the fiber). Desirably, the tea-bag paper has a heat-sealable thermoplastic such as PVC or polypropylene, as a component fiber, at least on the food-facing surface 20.

In yet another embodiment of the present invention, sheet 12 is a 1-1.2 ounce nonwoven material that does not contain cellulosic fibers. Like the tea-bag paper, this material is desirable because it may be permanently attached to itself with methods such as ultrasonic, pressure, or thermal bonding methods without the use of additional adhesives.

The food-facing surface 20 of article 10 may be coated with a material that allows the food-facing surface 20 to be cleanable by wiping so that the article 10 may be used for two or three uses instead of a single use. For example, it is contemplated that sheet 12 may be a laminate of paper/nonwoven materials, and a plastic material. In one embodiment, a paper or nonwoven material is laminated to a thin sheet of polyester, polyethylene, or similar material. In a desired embodiment, a paper or nonwoven material is coated at the food-facing surface 20 with a polytetrafluoroethene or polytetrafluoroethylene coating.

With respect to the embodiment of the present invention having a laminated sheet 12, after the article 10 is used, the food-facing surface 20 may be wiped so that the article 10 may be used to cover another type of food for heating. It is not intended that the article 10 will be fully cleaned after wiping; the act of wiping merely extends the use of article 10 through the preparation of a single meal. For example, a user may wish to reheat a plate of meat, a dish of vegetables, and a cup of sauce, separately in that order. After the meat has been heated underneath the article 10, the user may wipe the food facing surface 20 with a paper towel or cloth. Article 10 is then used to cover the dish of vegetables for heating. Article 10 is again removed and may be wiped so that it can be used to cover the cup of sauce for heating. The article 10 is disposed in the trash after the three uses.

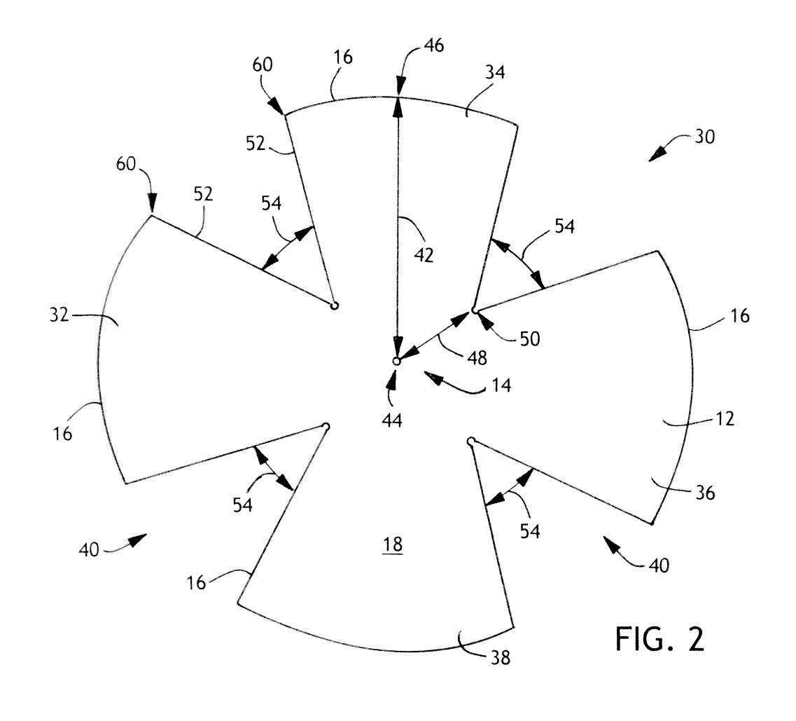

Sheet 12 is formed into a blank 30 shown in FIG. 2. In this particular embodiment, the blank 30 is cut into a cross-shape that fits within a circular area. Generally, blank 30 can be described as a circular sheet having a plurality of notched areas 40 therein. The blank 30 is defined by a top portion 14 surrounded by a number of panels 32-38 that together form the side portion 16 after the blank is fully assembled. A major radius 42 of blank 30 is measured from center point 44 to the mid-point of an outer edge 46 of a panel 16. A minor radius 48 of the top portion 14 is measured from center point 44 to the apex 50 of the notched area 40. The notched areas 40 are defined by inner edges 52 that converge at apex 50 at an angle 54.

In the embodiment shown in FIG. 2, the major radii 42 of each panel 16 are substantially equivalent. However, it is contemplated opposing panels may have different major radius 42 values. For example, panels 34 and 38 may have major radii 42 that are substantially equivalent; and panels, 32 and 36 may have major radii 42 that are substantially equivalent. However, the major radii 42 of panels 34 and 38 may be different from the major radii 42 of panels 36 and 32. This would be the case if blank 30 had an overall oval shape.

In the embodiment shown in FIG. 2, the minor radius 48 between each panel is substantially equivalent. However, it is contemplated that one or more of the minor radii 48 may be different. For example, suppose the minor radius 48 located between panels 34 and 36 was longer than the other major radii 48, which are equal. This example results in a shape that is symmetrical about an access that is parallel to the major radius 48 located between panels 34 and 36.

A blank 30, such as that shown in FIG. 2, may be assembled by bringing each inner edge 52 together and forming a permanent attachment. For example, each corner 60 may be brought together and a seam 62 formed from corners 60 to apex 50. Seam 62 may be a fin-seam as shown in FIG. 2A. Desirably, the fin-seem is created by binding the food-facing surface 20 together. As mentioned previously, the permanent attachment may be made by ultrasonic bonding, thermal bonding, pressure bonding methods, or by other methods such as sewing, gluing, or crimping (as is known in the coffee filter art). Suitable adhesives include a polyamide or polypropylene based with very little ethylene content. For example, two possible adhesives are Huntsman RT2115 or Huntsman RT2215, available from Huntsman International LLC. However, it is contemplated that various other adhesives may be used provided that they are food safe and can withstand microwave heating.

The article 10 is sufficiently light to allow it to be draped over food 20 for heating, but it is also sufficiently heavy to prevent the microwave sheet 12 from being blown off by steam during the microwave heating of food. The stiffness of sheet 12 is such that when the seams 62 are formed, they act as structural members. (Stiffness may be determined by the following: “Standard Test Method for Stiffness of Nonwoven Fabrics Using the Cantilever Test,” Standard Test: IST 90.1 (95), pp. 77-78; or ASTM D5732-95(2001) “Standard Test Method for Stiffness of Nonwoven Fabrics Using the Cantilever Test”.) When more seams are used to create article 10, such as when there are more than four panels, it may be possible to use a sheet 12 with reduced stiffness as compared to an article 10 with fewer seams.

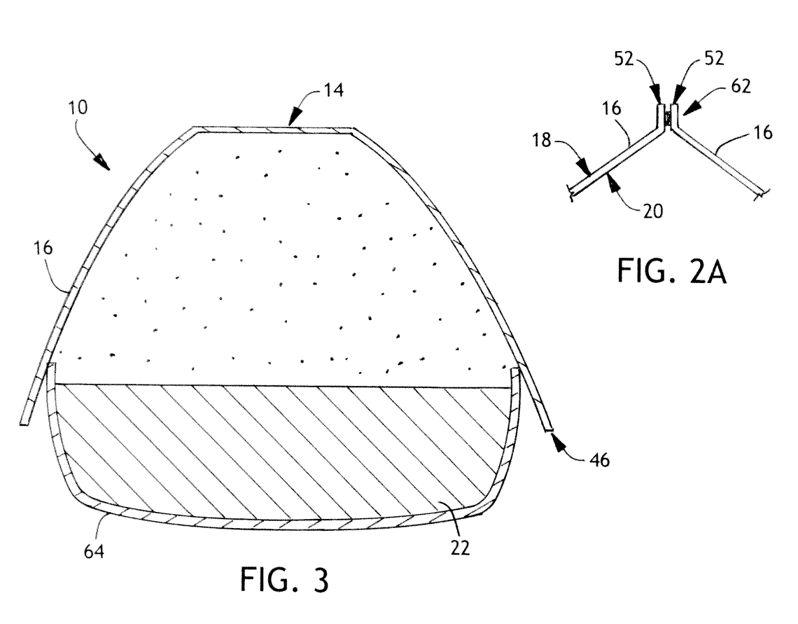

Article 10 may be sized to completely cover a dish 64 so that the outer edge 46 contacts the floor 70 of the microwave cavity 72 (see FIG. 1), or the article 10 may be sized to tent over a dish 64 (see FIG. 3).

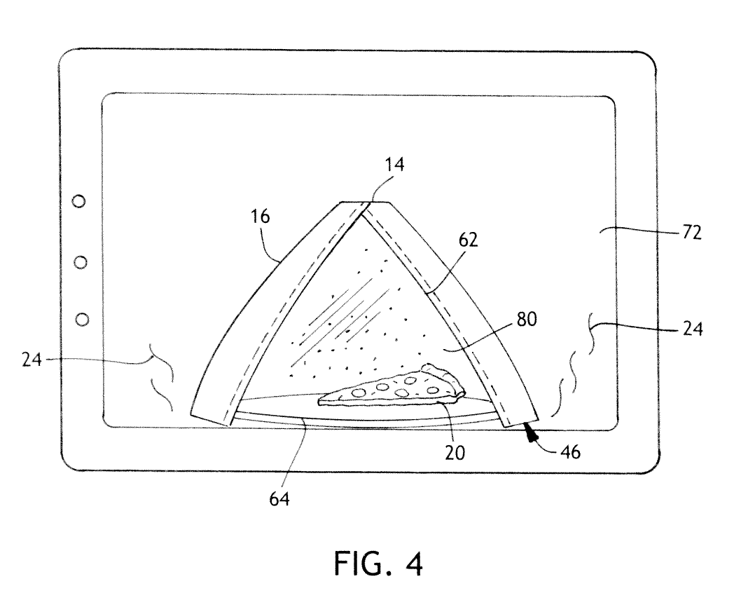

Shown in FIG. 4 is an article 10 having the same characteristics of the previously described embodiments, with the exception that it includes a translucent window 80. The translucent window 80 allows a user to observe what is happening with the food 20 as it is being heated. Desirably, the translucent window 80 occupies about 10 to about 40 percent of the overall surface area of the article 10 as calculated from comparing a surface area of blank 30 to a surface area of the translucent window 80. However, it may be desirable to have the translucent window 80 occupy no more than about 30 percent, or about 25 percent of the overall surface area of blank 30.

It is contemplated that the article 10 may include vents (not shown) for letting steam and vapor pass from the food to the microwave cavity. Vents may be desired if the sheet 12 material is air impermeable, or if there is a desire for even greater ventilation than can be offered by sheet material 12. Vents may be slits or holes that vary in size from about 0.5 mm to about 4 mm in diameter or length. The vents may be placed on the top portion, the side portion, or even the optional translucent window 80.

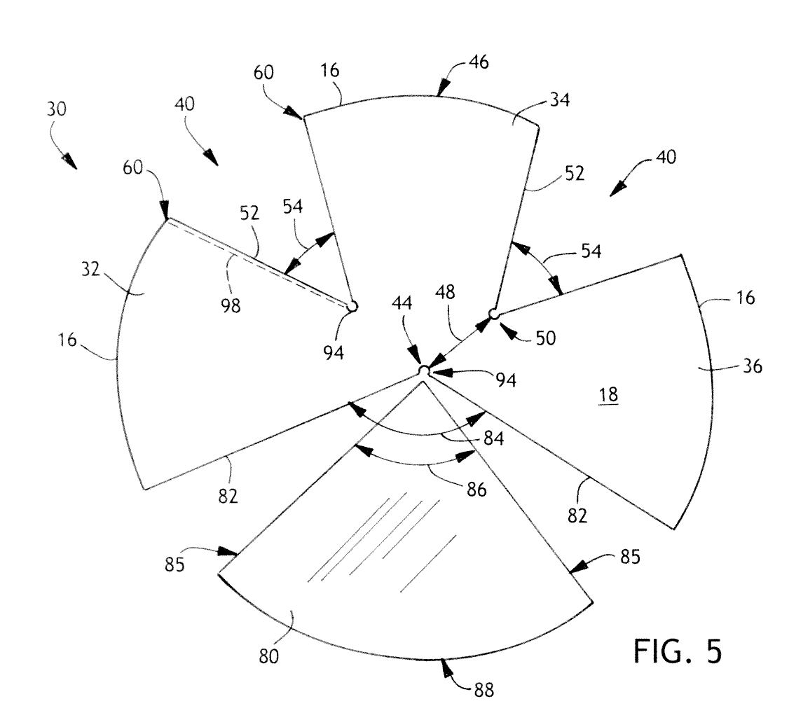

Shown in FIG. 5 is a blank 30 and window 80 (in an unassembled state) which corresponds to the example of article 10 shown in FIG. 4. In this non-limiting example, the inner edges 82 that will be connected to window 80 converge together at the center point 44 at an angle 84 of about 30 to about 48 degrees, or about 32 to about 36 degrees. The window 80 has outer edges 85 converging together at an angle 86 of about 41 to about 54 degrees. Desirably, angle 86 is about 90 degrees. In this particular example, the window 80 replaces the panel 38 of FIG. 2. It is contemplated that a second or third window 80 may replace or be incorporated into one of the other panels 32-36 (FIG. 2).

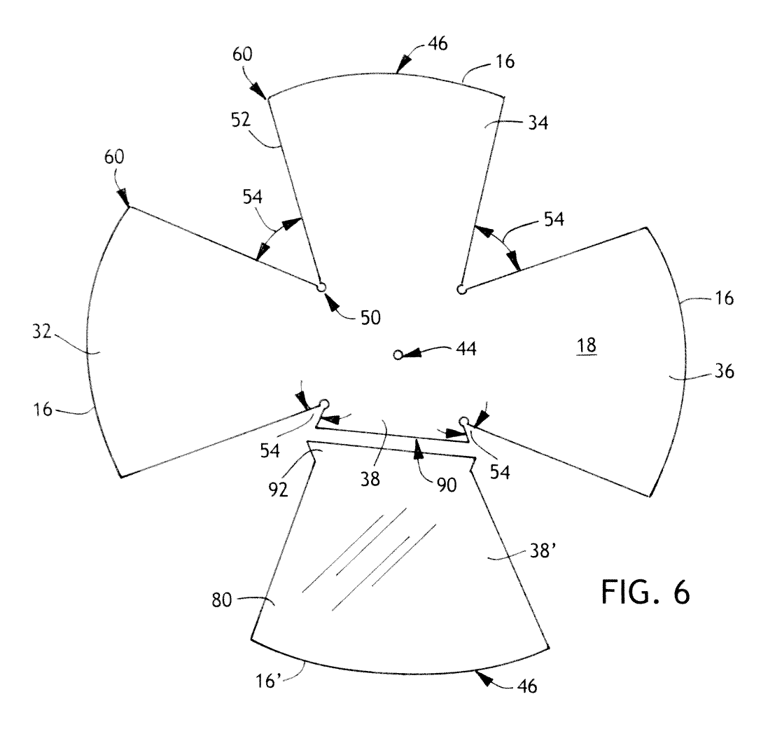

Shown in FIG. 6 is another non-limiting example of a blank 30 and a window 80, in an unassembled state. In this embodiment, the panel 38 is truncated leaving a truncated edge 90. The window 80 is the same area as the removed truncated portion of panel 38 (not shown) with the exception of the addition of margin 92 that is used to connect window 80 to edge 90. This window 80 is essentially a replacement panel 38′. Like the other panels 16, this panel 16′ may have a rounded outer edge 46.

Suitable materials for the window 80 include but are not limited to polyethylene and polyester (PET). These films are desirably transparent and food safe. It is contemplated that window 80 may be an air impermeable film, or it may be air impermeable because it contains a plurality of small apertures (about 0.5 mm in diameter) or has a porous structure.

Regardless of the particular embodiment of the present invention, each apex 50 has notch 94 located therein (see FIG. 5), which is preferably rounded to reduce the stress concentration at the apex 50. The notch 94 helps to define a margin 98 along each edge 52 for the purpose of connecting the inner edges 52 together as seen in FIG. 2A. The same principle happens at the inner edges 82, where there is a notch 94 coinciding with the center point 44.

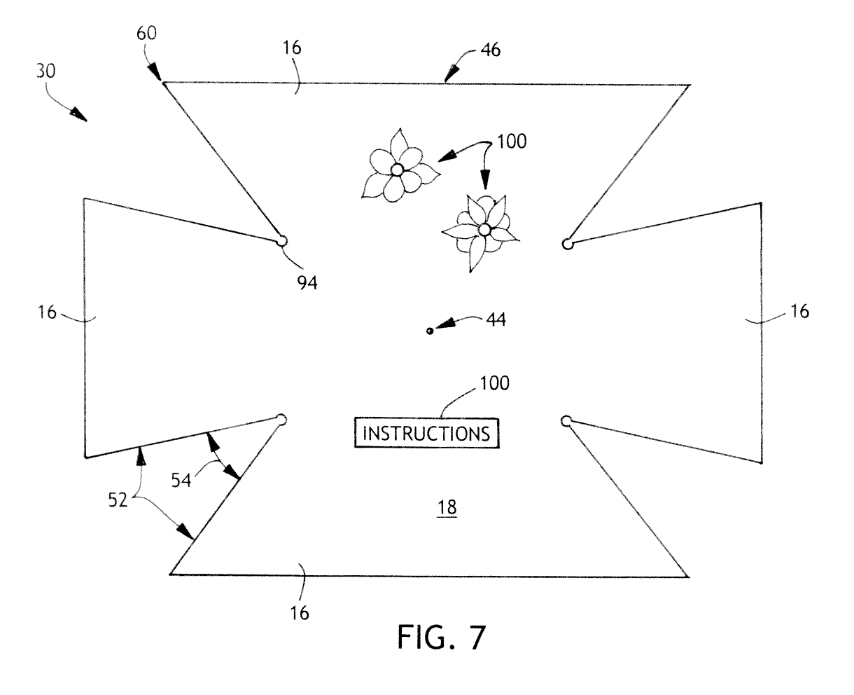

Shown in FIG. 7 is one example of a blank 30 from which a rectangular version of article 10 is formed. This embodiment of article 10 may be preferred for dishes that are rectangular in shape. Having the same general components and features as the previous embodiments (including a possible window 80), this rectangular article 10 will not touch the food that it covers either before or after heating in the microwave.

Also shown by way of example in FIG. 7 are various indicia 100 that may be placed at the outer surface 18. The indicia 100 may be decorative or informational. For example, the indicia 100 may include a pattern, design, picture or the like that is aesthetic in nature. The indicia 100 may also or instead be alphanumeric characters that are informational only, such as a set of instructions or safety warnings, or it may be purely aesthetic.

Each of the embodiments may be folded flat for storage prior to use. For example, in reference to FIG. 2, each of the articles 10 may be flattened by folding the panels 34 and 38 along major radius 42, so that the food-facing surface 20 is brought into contact with each other. This creates a first fold. The article 10 may be further folded to create a second fold along the major radius 42 coinciding with the panels 32 and 36. However, it is contemplated that the article 10 may be folded in other flattened configurations, and should not be limited to this single description of folds.

It is contemplated that the article 10 may be packaged with instructions. Such instructions may include information regarding food safety or the like. For example, the instructions may advise against reusing a wipeable article 10 after a certain period of time. In particular, it may be intended that the wipeable article 10 be disposed of within about 2 hours after its initial use, the rationale being that this is a commonly recommended time for food to sit out before it is considered unadvisable for consumption due to potential bacterial growth.

In operation, the user unfolds the article 10, and tents it over the food 22 located on a surface or in a receptacle such as a dish 64. If the sheet 12 from which the article 10 is constructed is air permeable, steam and water vapor 24 will be primarily emitted into the microwave cavity 72 through the side panels 16 and top portion 14 (see FIG. 1). If the article 10 has a relatively low porosity, or is air impermeable, the steam and water vapor 24 will be released from the interior volume of the article 10 about the outer edge 46 (see FIG. 4).

If the article 10 does not have a wipeable food-facing surface 20 as described above, desirably, it is disposed of after a single use. If the article 10 has a wipeable food-facing surface 20, it may be immediately reused about two or more times to complete the preparation of a meal.

We claim:

1. An article for covering a body of food for microwave heating comprising:
a flexible sheet defining an outer surface and an opposite food-facing surface, and a top portion and a side portion, wherein the side portion comprises a plurality of panels permanently attached together to form seams, and wherein the top portion lies in an intersecting plane with respect to the side portion;
wherein the top portion is elevated above a plane by the side portions to create a volume.

2. The article of claim 1 wherein the flexible sheet comprises a nonwoven material.

3. The article of claim 2 wherein the flexible sheet comprises a poly(tetrafluoroethene) or poly(tetrafluoroethylene) coating at the food-facing surface.

4. The article of claim 1 wherein the flexible sheet is air permeable.

5. The article of claim 1 wherein the flexible sheet comprises a spunbond material.

6. The article of claim 1 wherein the seams comprise fin seams created by connecting the sheet inner edges at the food-facing surface.

7. The article of claim 1 wherein the plurality of panels comprises four panels.

8. The article of claim 1 further comprising a window located in the side portion.

9. The article of claim 8 wherein one of the plurality of panels comprises a window.

10. The article of claim 1 further including indicia at the outer surface.

11. A method of manufacturing a three-dimensional article for covering a body of food for microwave heating comprising the steps of:
forming a blank from a sheet of material by creating an overall shape;
placing a plurality of notches in the blank that extend from an outer edge toward a center point, each of the plurality of notches defined by a pair of inner edges converging into a corresponding apex;
permanently attaching each pair of inner edges together to form seams, wherein each of the seams extend from the outer edge to the corresponding apex;
wherein the step of permanently attaching each pair of inner edges creates the three-dimensional article having a volume by creating a top portion and a side portion.

12. The method of claim 11 wherein the overall shape is a circle.

13. The method of claim 11 wherein the overall shape is a rectangle.

14. The method of claim 11 wherein the plurality of notches comprises three notches.

15. The method of claim 14 wherein the side portion comprises a window.

16. The method of claim 11 further including the step of folding the article to create a first fold.

17. The method of claim 11 further comprising the step of folding the article to create a second fold.

18. The method of claim 11 further including the step of packaging the article with a set of instructions regarding food safety.

19. A method of covering a body of food with the article of claim 1 for heating in a microwave, the method comprising the steps of:
placing a body of food in a microwave;
placing the article over the body of food;
heating the body of food with microwave energy;
removing the article from the microwave; and
disposing of the article.

20. The method of claim 19 further comprising the steps of:
wiping a food-facing surface of the article so it may be reused within a two-hour period; wherein the disposing of the article takes place within two hours after an initial step of heating the body of food in a microwave.
